(19) United States
(12) Patent Application Publication
(10) Pub. No.: US 2024/0408965 A1
(43) Pub. Date: Dec. 12, 2024

(54) AUDIO USER INTERFACE

(71) Applicant: Bose Corporation, Framingham, MA (US)

(72) Inventors: Steven J. Forrester, Southborough, MA (US); Gibeom Lee, Pittsburgh, PA (US); Robert A. Warden, Southborough, MA (US); Nicholas K. Lade, Waltham, MA (US); Jeffery R. Vautin, Worcester, MA (US)

(73) Assignee: Bose Corporation, Framingham, MA (US)

(21) Appl. No.: 18/741,366

(22) Filed: Jun. 12, 2024

Related U.S. Application Data
(60) Provisional application No. 63/472,507, filed on Jun. 12, 2023.

(51) Int. Cl. B60K 35/81; B60K 35/22; B60K 35/28

(52) U.S. Cl. CPC B60K 35/81; B60K 35/22; B60K 35/28; B60K 2360/115; B60K 2360/1438; B60K 2360/162; B60K 2360/48

(57) ABSTRACT

An audio system, method, and computer readable medium that controls an audio system having a visual display and an input sensor for accepting user selections is provided. The visual display visually presents a primary panel, a first sub-panel, and a second sub-panel. The primary panel occupies a larger area of the visual display than do each of the first sub-panel and the second sub-panel. In various examples, audio and/or telephone configuration settings are displayed depending upon context.

### CROSS REFERENCE TO RELATED APPLICATIONS

This application claims a benefit under 35 USC § 119(e) to U.S. Patent Application Ser. No. 63/472,507, filed on Jun. 12, 2023, titled “AUDIO USER INTERFACE” the content of which is incorporated herein in its entirety for all purposes.

### BACKGROUND

Automotive and vehicular audio systems are becoming more sophisticated over time, and now integrate various audio sources, such as radio broadcasts, nearby wireless devices, telephone calls, navigation prompts, streaming audio, and the like. Some audio system do or will have seat specific audio adjustments, such as volume adjustment so that one occupant may listen to audio at a louder output than another occupant, or the ability to play different content to one occupant than another, e.g., navigation prompts only to the driver or telephone call audio only to the recipient or simply different music or audio sources to two different occupant positions. There exists a need for user's to interact with the various user settings and preferences in a natural and easily understandable way.

### SUMMARY

Systems and methods disclosed herein are directed to user interface systems, methods, and applications for controlling audio output from an audio system.

According to various aspects, audio systems, methods, and computer readable media that control an audio system are provided. The audio system(s) include a visual display and an input sensor for accepting user selections. The audio systems, methods, and computer readable media display a primary panel, a first sub-panel, and a second sub-panel. The primary panel occupies a primary area of the visual display, and the primary area of the visual display is greater than a first area occupied by the first sub-panel and greater than a second area occupied by the second sub-panel.

In various examples, an audio settings configuration panel is displayed in a position of the first and second sub-panels in response to a user selection of an audio control input.

In some examples, an audio settings configuration panel includes at least a primary volume control, a secondary volume control, and a zone selection control. In certain cases, the zone selection control includes at least three zones representative of at least three occupant locations.

According to some examples, in response to a user selection of one of the first or second sub-panels, the primary panel displays a visual content associated with an application that was previously active in the selected one of the first or second sub-panels.

In various examples, a telephone audio configuration panel is displayed in response to an incoming audio call, and in certain examples the telephone audio configuration panel includes user selectable options to route the incoming audio call to one of at least two occupant locations.

Still other aspects, examples, and advantages of these exemplary aspects and examples are discussed in detail below. Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification but are not intended as a definition of the limits of the invention(s). In the figures, identical or nearly identical components illustrated in various figures may be represented by a like reference character or numeral. For purposes of clarity, not every component may be labeled in every figure. In the figures:

FIG. 1 is an example graphical display interface in accord with various examples described herein;

FIG. 2A is an example graphical display interface in accord with FIG. 1 illustrating an audio settings configuration panel;

FIG. 2B is an example graphical display interface in accord with FIG. 1 displaying a variation of the audio settings configuration panel of FIG. 2A;

FIG. 2C is an example graphical display interface in accord with FIG. 1 displaying a further variation of the audio settings configuration panel of FIG. 2A;

FIG. 3A is an example graphical display interface in accord with FIG. 1 illustrating an audio playback application displayed in a primary panel;

FIG. 3B is an example graphical display interface illustrating a variation of that shown in FIG. 3A;

FIG. 4 is an example graphical display interface in accord with FIG. 1 illustrating a telephone application displayed in a primary panel;

FIG. 5A is an example graphical display interface in accord with FIG. 1 displaying a telephone application pop-up;

FIG. 5B is an example graphical display interface in accord with FIG. 1 displaying a variation of the telephone application pop-up of FIG. 5A;

FIG. 5C is an example graphical display interface in accord with FIG. 1 displaying a further variation of the telephone application pop-up of FIG. 5A;

FIG. 6A is an example graphical display interface in accord with FIG. 1 illustrating a telephone application panel;

FIG. 6B is an example graphical display interface in accord with FIG. 6A illustrating an example audio settings configuration panel when a telephone application is active; and

FIG. 6C is an example graphical display interface illustrating a variation of the example audio settings configuration panel of FIG. 6B.

### DETAILED DESCRIPTION

Various aspects, examples, and features of user interface systems, methods, and applications are illustrated by the accompanying figures.

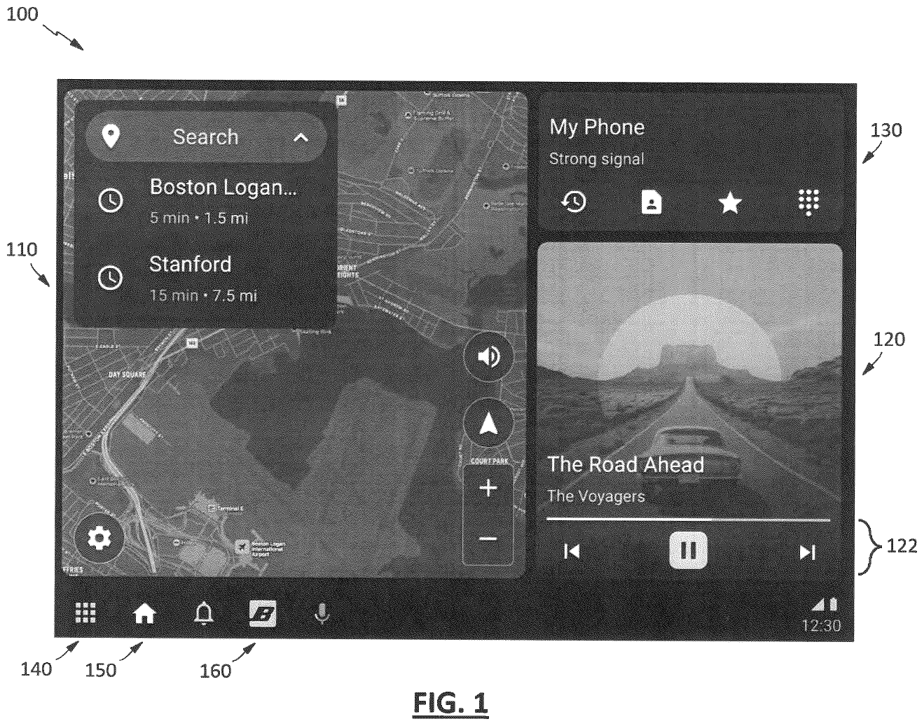

FIG. 1 illustrates a user interface display 100, such as may be presented on a touchscreen or other suitable device, graphically subdivided into and displaying a primary panel 110 that may take up a majority of the display, a first sub-panel 120, and a second sub-panel 130. In various examples, the first and second sub-panels 120, 130 may be displayed to the side of the primary panel 110, and in various examples the first sub-panel 120 may be displayed with more display space than the second sub-panel 130. In the example shown, the second sub-panel 130 is illustrated as being displayed above the first sub-panel 120, but any arrangement of the sub-panels and the primary panel may be suitable in various examples.

Also illustrated in the example user interface display 100 of FIG. 1 is a set of icons including an app drawer icon 140, a home icon 150, and an audio controls icon 160, the last of which in this case is illustrated as a logo of Bose Corporation, headquartered in Framingham, MA USA. The audio controls icon 160 may variously be equivalently referred to herein as a Bose logo 160.

Depending upon the history of user interaction with the user interface display 100, the various panels (the primary panel 110 and first and second sub-panels 120, 130) may display various content or represent a user interface or ‘window’ of various applications, routines, or sub-routines running on a computing platform (e.g., a processor coupled with memory storing executable instructions and other data and coupled to the device upon which the user interface display 100 is presented). The user interface display 100 may be generated or controlled by such a computing platform.

In the example user interface display 100 of FIG. 1, a navigation app is shown in the primary panel 110, an audio playback app is shown in the first sub-panel 120, and a telephone app is shown in the second sub-panel 130. The term app is short for application, such as a computer application which may be a user-selectable application. Each of the panels 110, 120, 130 may display any of various apps at various times and in various examples. In this example, the audio playback app includes album artwork as well as track information and shuttle controls 122.

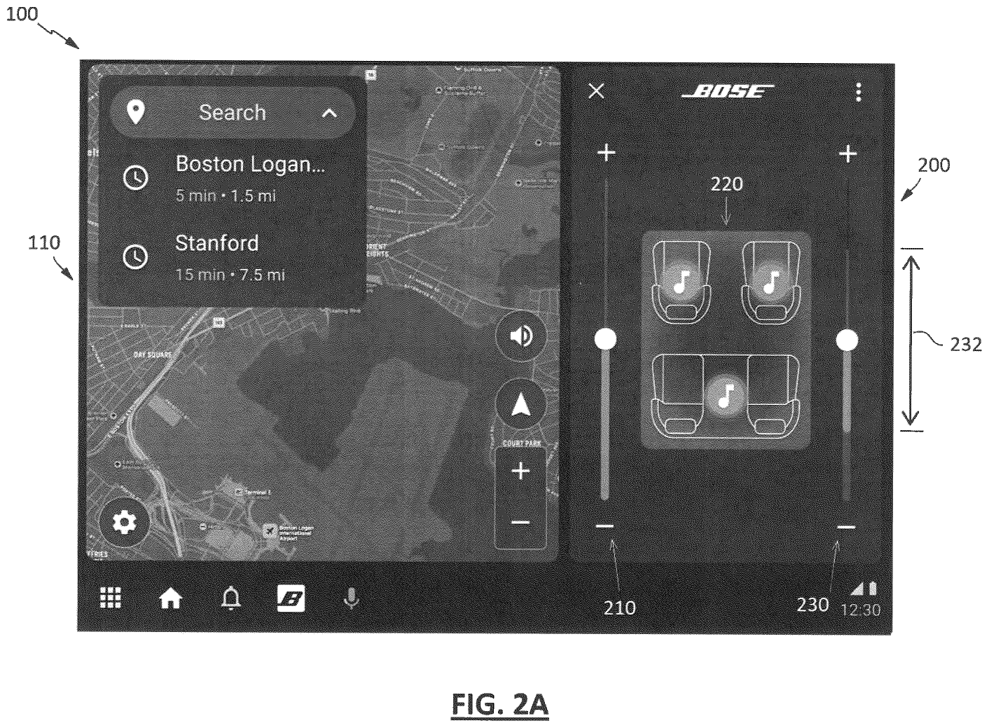

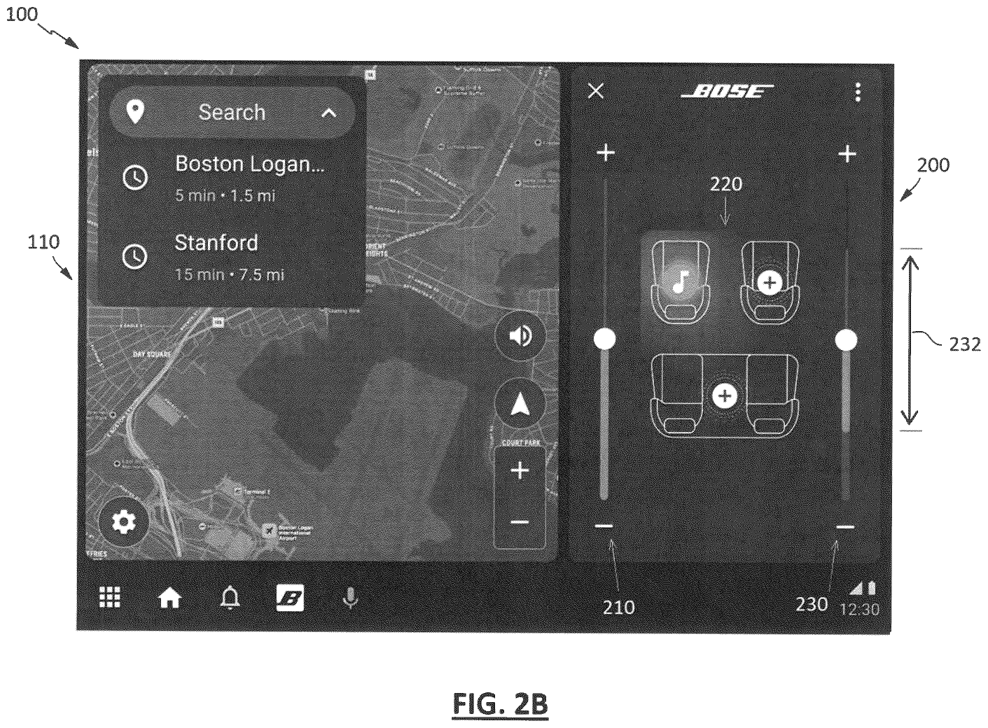

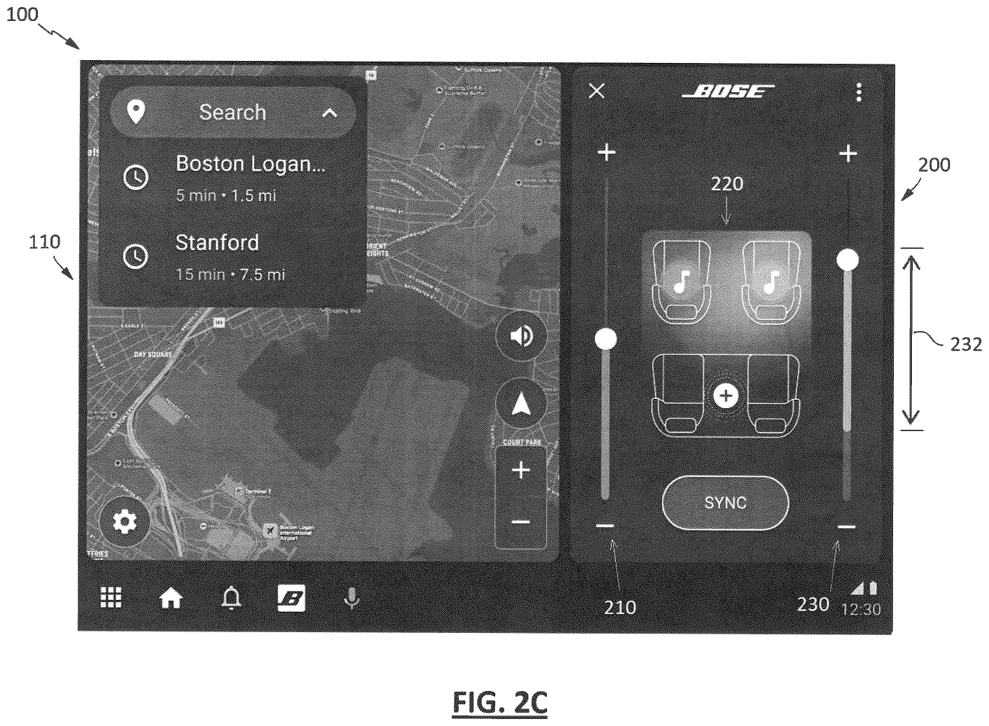

FIGS. 2-5 illustrate various changes to the user interface display 100 and functional features thereof as a user interacts with the interface. In general, user interaction may include selecting objects or items such as icons, buttons, panels, etc., and may include manipulating items such as sliders, knobs, or the like. Any form of user input methods and devices may be suitable in various embodiments. For example, if the user interface display 100 is presented on a touchscreen, merely tapping the touchscreen with a finger may be sufficient to select various objects and items. Manipulating various objects and items, such as rotation, zoom, moving (e.g., relocating objects or sliding a setting indicator) may be completed by touching the touchscreen with one or more fingers and moving the one or more fingers in various motions while maintaining contact with the touchscreen. Such interactions and gestures are well-known methods of interacting and providing user input. Other methods and devices of user input are also suitable in various examples. Such as a mouse, touchpad, or other user interface devices, e.g., physical knobs and buttons. In various examples, a console mounted user input device in a vehicle may provide the user input capability, and may operate in conjunction with a touchscreen device, e.g., a user may be able to select an object or item by tapping the screen or by rotating a physical knob to highlight the object or item and then clicking the knob or pressing another button, whichever the user prefers.

For example, FIG. 2A illustrates an example result of selecting the Bose logo 160. In such a case, the user interface display 100 changes to display an audio settings configuration panel 200, while leaving the primary panel 110 intact (in this case, displaying a navigation app). In this example, the audio settings configuration panel 200 takes over the positions of the first and second sub-panels 120, 130, but other examples may position the audio settings configuration panel 200 differently, such as to take the place of only one or the other of the first and second sub-panels 120, 130.

The example audio settings configuration panel 200 includes a primary volume control 210, a zone selection control 220, and a secondary volume control 230. The primary volume control 210 controls an overall system audio output volume, and a default setting may include that all occupant locations receive the same audio content at the same volume, as established by the primary volume control 210. In some examples, however, an audio system may be capable of delivering differing volumes to differing occupant locations, such as to a front passenger and/or one or more rear passengers. Accordingly, the secondary volume control 230 may control a differing volume (as described further below) for one or more secondary seating positions.

In the example audio settings configuration panel 200 the zone selection control 220 includes graphical icons to indicate various occupant locations (e.g., seating positions). In this example, the indicated occupant locations are front left, front right, and rear locations. Each of these occupant locations may be selected or deselected to participate in receiving the current audio playback content, as illustrated further in FIG. 2B.

Further in the example audio settings configuration panel 200 the secondary volume control 230 includes an indication of a range 232 of volumes that are achievable in a secondary listening location for when it may be desired to listen at differing volume levels. For the purposes of the examples described herein, one or more ‘secondary’ occupant locations may be defined as being those locations whose volume is separately controlled by the secondary volume control 230 relative to the primary volume control 210. For instance, in many cases, a driver's occupant location may be defined to be the primary listening zone, and the secondary volume control 230 may control a playback volume in all other locations capable of being controlled to have a higher or lower volume. The amount of higher or lower volume the audio system is capable of may be limited. For instance, when the primary volume control 210 is set to a loud setting, it may not be possible to achieve total quiet in a secondary occupant location. Accordingly, the secondary volume achievable given the primary volume setting is indicated by the range 232.

FIG. 2B illustrates de-selecting one or more occupant locations from participating in the audio content playback. In the example shown, the front right location and the rear location have been deselected, and the audio content playback is limited (to the greatest extent possible) to the front left location.

FIG. 2C illustrates adjusting the secondary volume in an example audio system for which the front left occupant location is the primary location and the front right location is selected to have a different playback volume according to the secondary volume control 230. In the example illustrated, the secondary volume control 230 is set to the highest possible according to the primary volume setting. To achieve a higher volume playback in the front right location would require a higher primary volume setting for this audio system. Other example audio systems may be capable of more or less volume differential between a primary volume level and a secondary volume level.

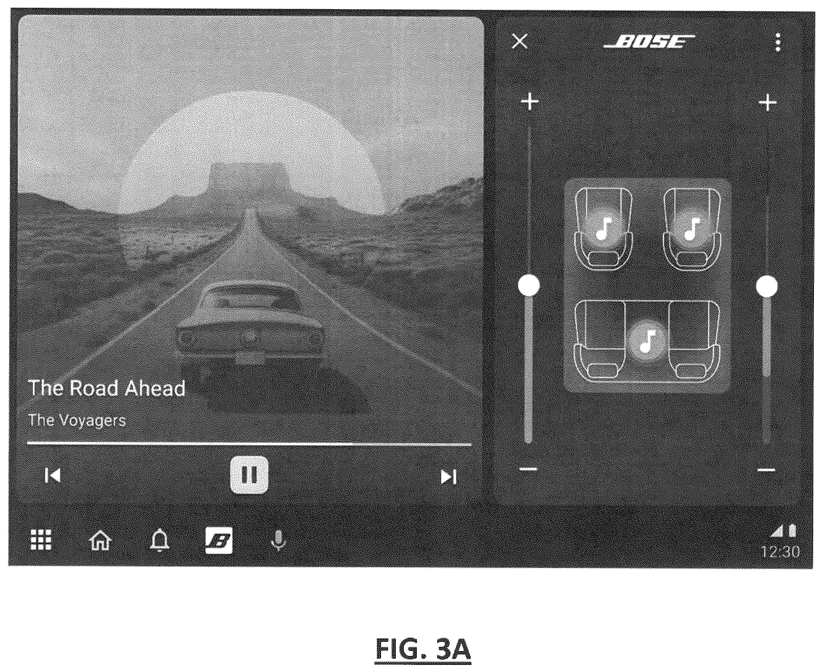

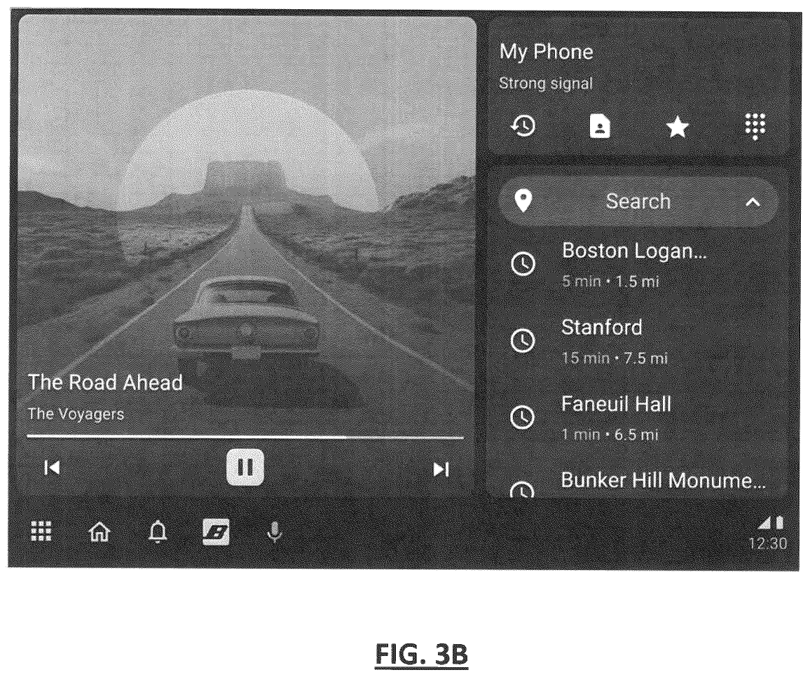

At any time, in the example user interface display 100, if the user selects the home icon 150, the device presenting the display may update the display back to that shown in FIG. 1 or similar. Referring back to FIG. 1, and at any time in various examples, a user may select the currently displayed content of any of the primary panel 110 or the first or second sub-panels 120, 130. For example, if a user selects the first sub-panel 120 as illustrated in FIG. 1, the user is selecting an audio playback app. When selected, whichever app currently occupies the selected panel may become the app shown in the primary panel 110, as illustrated in FIG. 3A for the example of the user selecting the audio playback app.

Referring to FIG. 3A, when the audio playback app is selected, user interface display 100 may be configured to also open the audio settings configuration panel 200 (as described above with reference to FIGS. 2A-2C) under a system configuration to presume that audio adjustments may be desired by the user, or based upon a default configuration in an audio system. In other examples, when an app is selected the selected app may be moved to occupy the primary panel 110 and the first and second sub-panels 120, 130 may be changed in a manner consistent with the user's desire to interact primarily with the selected app, as illustrated in one example in FIG. 3B, in which example the navigation app and the audio playback app of FIG. 1 have swapped positions in the user interface display 100. Additionally, alternating the user interface display 100 between that of FIG. 3A and FIG. 3B may be achieved by alternately selecting the Bose icon 160 and/or selecting a ‘close’ option (illustrated by an X) in the audio settings configuration panel 200.

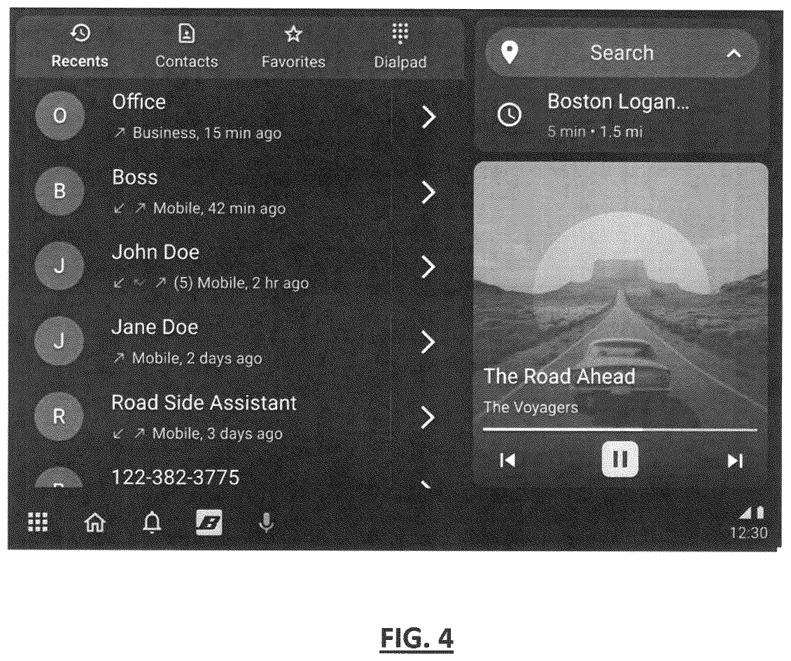

Referring again to FIG. 1, which may be considered an example ‘home’ version of the user interface display 100, another illustration of what happens when a user selects another of the apps shown in either of the first or second sub-panels 120, 130, is illustrated by FIG. 4. For instance, in the event a user selects the secondary sub-panel 130 of FIG. 1 (which shows the telephone app), the user interface display 100 may swap the apps shown in each of the primary panel 110 and the secondary sub-panel 130, as shown in FIG. 4 wherein the telephone app is now shown in the primary panel 110 and the navigation app now populates the secondary sub-panel 130.

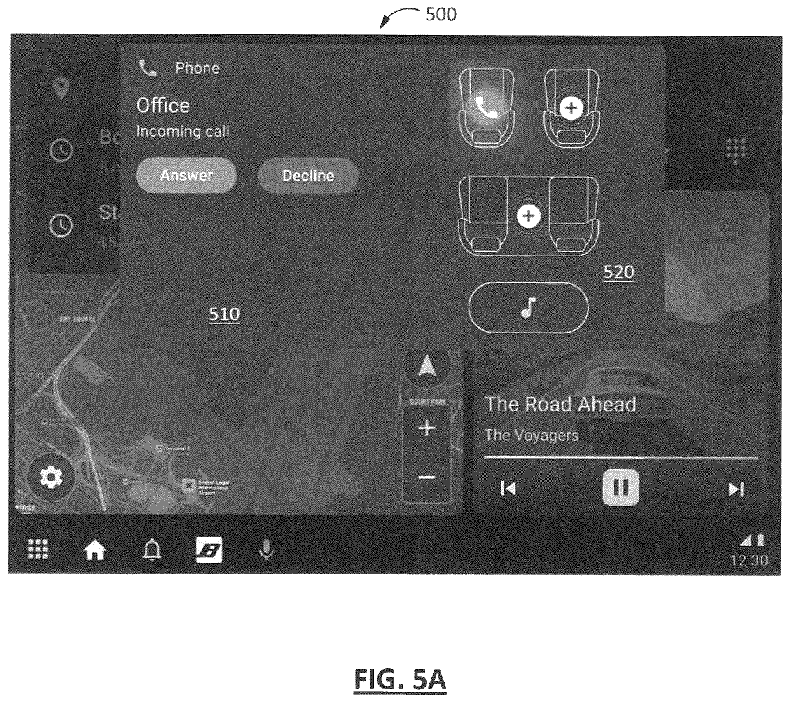

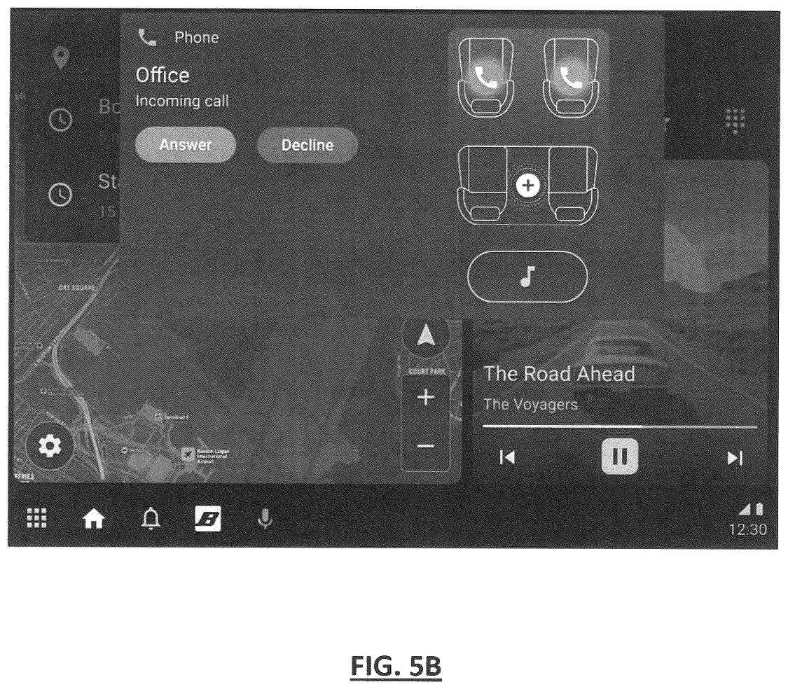

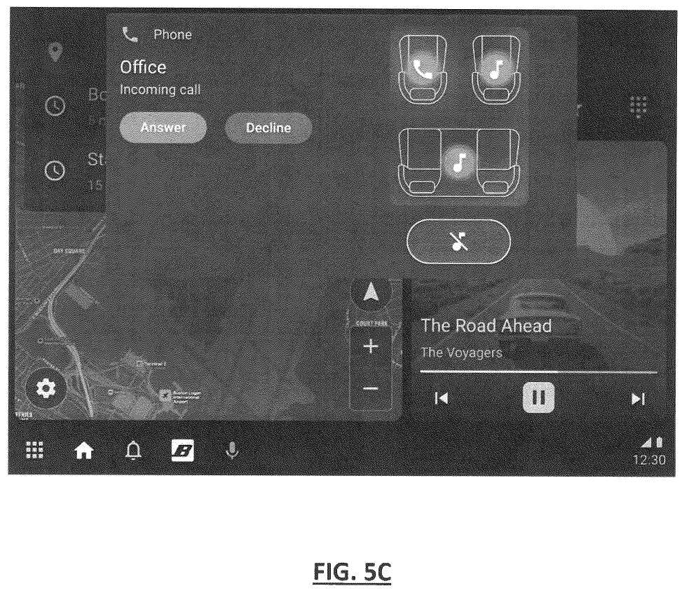

To illustrate further operation of the user interface display 100, and with reference to FIG. 5A, an incoming telephone call may occur at any time. In response to the incoming telephone call, the user interface display 100 may display a telephone pop-up 500 to allow one or more user responses to the incoming call. The example pop-up 500 includes a telephone sub-pop-up 510 and an audio settings sub-pop-up 520. The telephone sub-pop-up 510 may include call information and displayed options to accept or reject the call. The audio settings sub-pop-up may provide various options to configure how the call audio and existing audio content playback may be affected upon answering the call. For example, a user may be enabled to select which of one or more occupant locations should receive the telephone audio which of one or more occupant locations should continue to receive any audio content playback, such as an existing audio program like music, an audiobook, or the like.

FIG. 5B illustrates a user making a selection in the audio settings sub-pop-up 520 and particularly shows selection of the front right occupant location to participate in the phone call, e.g., to hear the incoming (far-end) caller.

FIG. 5C is similar to FIG. 5B but shows a selection to enable audio content playback, distinct from the telephone audio, to be played in the front right and rear occupant locations.

Each of the selections in FIGS. 5B and 5C may become effective upon accepting the incoming call, such as by selecting the ‘Answer’ button shown.

In various examples, if no selections such as those in FIGS. 5B and 5C are made, and instead the ‘Answer’ button is selected as shown inf FIG. 5A, all other audio may cease (e.g., pause or mute) and the incoming (far-end) caller audio will be routed to the front left occupant location only.

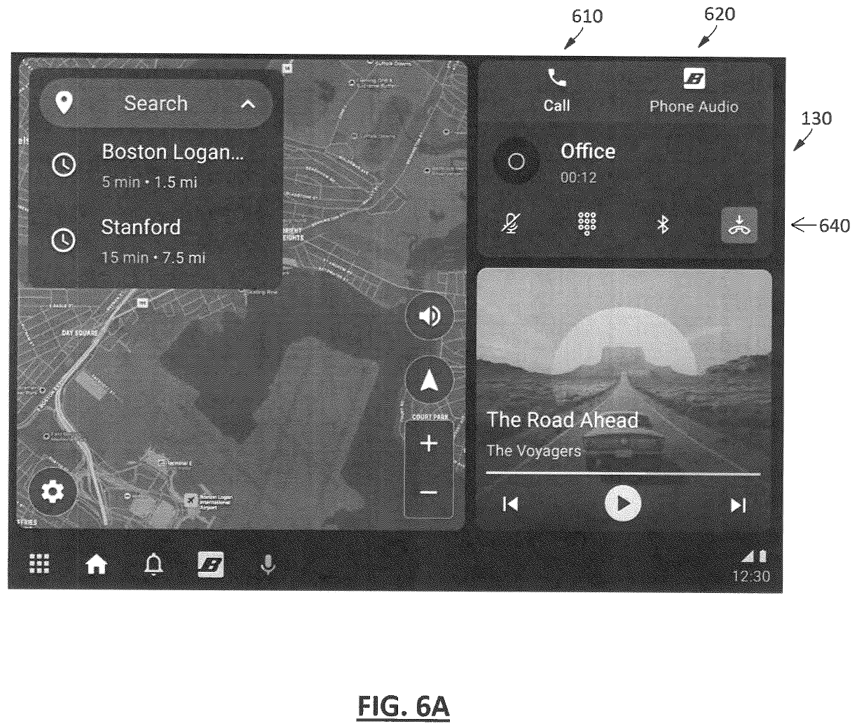

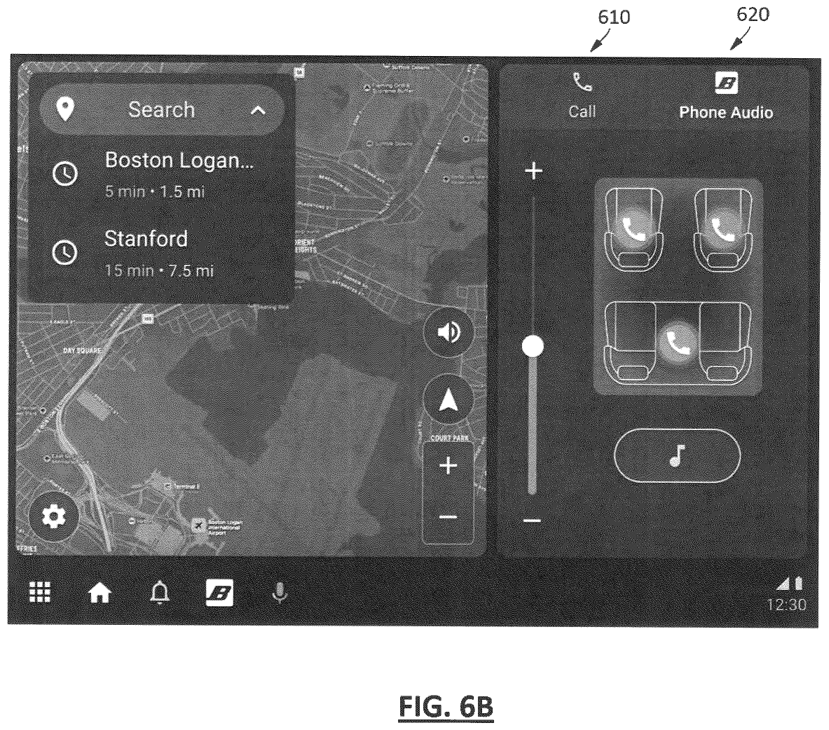

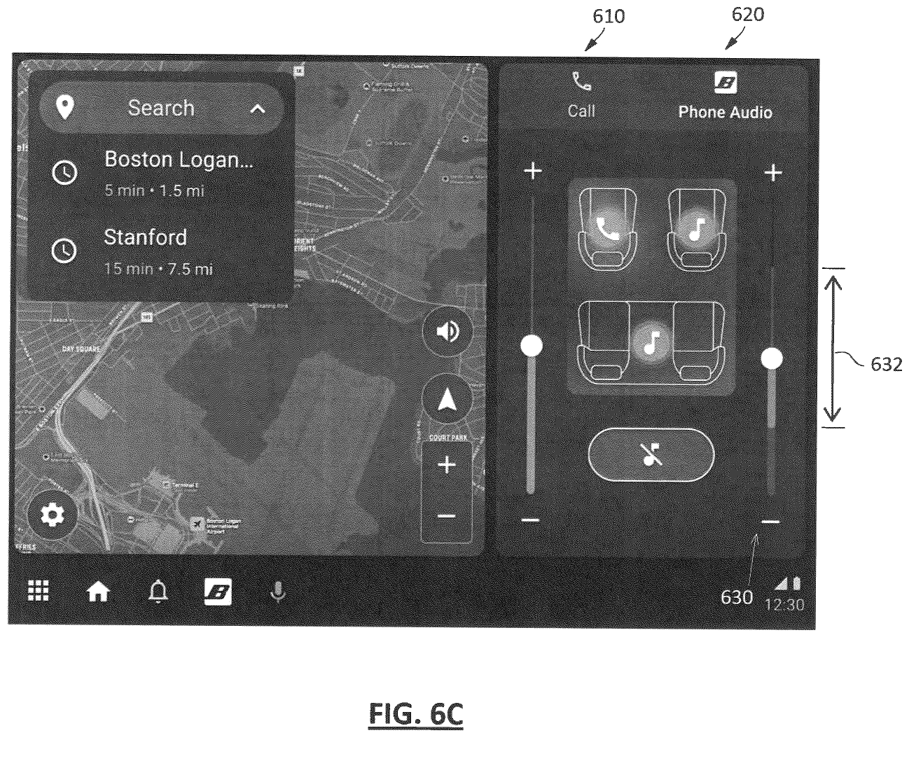

FIG. 6A illustrates an example change to the user interface display 100 upon accepting a telephone call. In this example, the secondary sub-panel 130 has changed to display information about the ongoing telephone call. In various examples, if the telephone app had populated a different panel before the call, the change may occur in said other panel. In this instance, the ongoing call information and options may require more space (or display area) and the user interface display 100 may accordingly display the secondary sub-panel 130 a bit larger than previously, as illustrated. In this example, the ongoing call version of the telephone app includes two tabs or high-level options of a call tab 610 and a phone audio tab 620.

FIG. 6B illustrates one example of the phone audio tab 620 being selected, and the specific display presented at various times may depend upon the current phone audio settings. As shown, the current phone audio settings include all occupant locations participating in the telephone call, which may at least mean that all occupants can hear the incoming (far-end) caller audio. A selection or deselection of one or more occupant locations may add or remove, respectively, the one or more occupant locations from hearing the incoming (far-end) caller audio, at least to the greatest extent the system is capable isolating the audio to one or more occupant locations under the operating conditions.

In some examples, such a selection or deselection of occupant locations may also enhance or reduce the level or quality of voice pick-up from the respective occupant locations. For example, when the rear occupant location is selected to hear the incoming call, an outgoing voice signal (near-end) may be configured to include, or pick-up, more of any rear occupant speaking. Accordingly, occupants in the selected positions may be able to participate in two-way conversation with the far-end caller more so than if their occupant location was deselected.

In addition, or instead of, having various selected occupant locations participate in an ongoing telephone call, FIG. 6C illustrates that various occupant locations may be selected to continue listening to other audio content playback, such as may be managed by the audio playback app as shown in the first sub-panel 120 of FIG. 1. Upon selection of audio content, the audio system (and the user interface display 100) may shift to delivering audio content playback to, e.g., secondary occupant locations, while maintaining the ongoing phone call at, e.g., a primary occupant location. In such a mode where one or more occupants are listening to a telephone call and one or more other occupants are listening to audio content playback, the user interface display 100 may display a secondary volume control 630, similar to that of secondary volume control 230 of FIG. 2A, to control the volume of audio content playback relative to that of the incoming (far-end) call audio. Such a secondary volume control 630 may include an indication of a range 632 of volumes that are achievable, similar to that of range 232 of FIG. 2A.

In various examples, any of the one or more occupant locations may be selected to be the primary occupant location and/or any of the one or more occupant locations may be selected to hear either of the ongoing call or the audio content playback. As shown in FIG. 6C, an option may be displayed to allow turning off the audio content playback.

According to various examples, to end a telephone call, a user may select the call tab 610 (if not already displayed) and select an option to end call 640, as illustrated in FIG. 6A.

In various examples, upon ending a telephone call, audio content playback settings may resume to what they were before accepting an incoming call (or initiating an outgoing call).

Examples of the methods and apparatuses discussed herein are not limited in application to the details of construction and the arrangement of components set forth in the above descriptions or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Also, the phraseology and terminology used herein is for the purpose of description and should not be regarded as limiting. Any references to examples, components, elements, acts, or functions of the systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation, unless the context reasonably implies otherwise.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An audio system comprising:
a visual display;
an input sensor to accept user selections; and
a controller coupled to the visual display and the input sensor and configured to cause the visual display to visually present to a user:
a primary panel,
a first sub-panel, and
a second sub-panel,
wherein the primary panel occupies a primary area of the visual display, the primary area of the visual display being greater than a first area occupied by the first sub-panel and greater than a second area occupied by the second sub-panel.

2. The audio system of claim 1 wherein the controller is further configured to cause the visual display to visually present an audio settings configuration panel in a position of the first and second sub-panels in response to a user selection of an audio control input.

3. The audio system of claim 1 wherein the controller is further configured to cause the visual display to visually present an audio settings configuration panel that graphically includes at least a primary volume control, a secondary volume control, and a zone selection control.

4. The audio system of claim 3 wherein the zone selection control includes at least three zones representative of at least three occupant locations.

5. The audio system of claim 1 wherein the controller is further configured, in response to a user selection of one of the first or second sub-panels, to cause the visual display to present in the primary panel a visual content associated with an application that was previously active in the selected one of the first or second sub-panels.

6. The audio system of claim 1 wherein the controller is further configured to cause the visual display to visually present a telephone audio configuration panel in response to an incoming audio call.

7. The audio system of claim 6 wherein the telephone audio configuration panel includes user selectable options to route the incoming audio call to one of at least two occupant locations.

8. A method of controlling an audio system that includes a visual display and an input sensor to accept user selections, the method comprising:
displaying, on the visual display, a primary panel occupying a primary area of the visual display;
displaying, on the visual display, a first sub-panel occupying a first area of the visual display; and
displaying, on the visual display, a second sub-panel occupying a second area of the visual display,
wherein the area of the visual display is greater than each of the first area of the visual display and the second area of the visual display.

9. The method of claim 8 further comprising displaying, on the visual display, an audio settings configuration panel in a position of the first and second sub-panels in response to a user selection of an audio control input.

10. The method of claim 8 further comprising displaying, on the visual display, an audio settings configuration panel that graphically includes at least a primary volume control, a secondary volume control, and a zone selection control.

11. The method of claim 10 wherein the zone selection control includes at least three zones representative of at least three occupant locations.

12. The method of claim 8 further comprising, in response to a user selection of one of the first or second sub-panels, displaying in the primary panel a visual content associated with an application that was previously active in the selected one of the first or second sub-panels.

13. The method of claim 8 further comprising displaying, on the visual display, a telephone audio configuration panel in response to an incoming audio call.

14. The method of claim 13 wherein the telephone audio configuration panel includes user selectable options to route the incoming audio call to one of at least two occupant locations.

15. A non-transitory computer readable medium having instructions stored thereon that, when executed by a processor, cause the processor to perform a method of controlling an audio system having a visual display and an input sensor to accept user selections, the method comprising:
causing the visual display to visually present a primary panel;
causing the visual display to visually present a first sub-panel; and
causing the visual display to visually present a second sub-panel,
wherein the primary panel occupies a primary area of the visual display, the primary area of the visual display being greater than a first area occupied by the first sub-panel and greater than a second area occupied by the second sub-panel.

16. The computer readable medium of claim 15 further comprising instructions to cause the visual display to visually present an audio settings configuration panel in a position of the first and second sub-panels in response to a user selection of an audio control input.

17. The computer readable medium of claim 15 further comprising instructions to cause the visual display to visually present an audio settings configuration panel that graphically includes at least a primary volume control, a secondary volume control, and a zone selection control.

18. The computer readable medium of claim 17 wherein the zone selection control includes at least three zones representative of at least three occupant locations.

19. The computer readable medium of claim 15 further comprising instructions to, in response to a user selection of one of the first or second sub-panels, cause the visual display to present in the primary panel a visual content associated with an application that was previously active in the selected one of the first or second sub-panels.

20. The computer readable medium of claim 15 further comprising instructions to cause the visual display to visually present a telephone audio configuration panel in response to an incoming audio call.
